(19) United States
(12) Patent Application Publication
(10) Pub. No.: US 2006/0250215 A1
(43) Pub. Date: Nov. 9, 2006

(54) Remote controlled security lock

(76) Inventor: Eric M. Norton, Bolivar, OH (US)

Correspondence Address: Galasso & Associates, LP, P.O. Box 26503, Austin, TX, 78755-0503, US

(21) Appl. No.: 11/415,783

(22) Filed: May 2, 2006

Related U.S. Application Data
(60) Provisional application No. 60/678,536, filed on May 6, 2005.

(51) Int. Cl. G05B 19/00

(52) U.S. Cl. 340/5.64

(57) ABSTRACT

A home or building security system that enables a user to activate and deactivate various items, such as the locking and unlocking of a door utilizing a wireless transmitter. The key fob includes various buttons such that when depressed, signals are transmitted from the key fob. A receiver/controller is positioned in the home or building proximate the locking mechanism of a door, such that upon the reception of a signal from the wireless transmitter a predetermined function is carried out by the receiver/controller, such as the locking and unlocking of the door.

### PRIORITY UNDER 35 U.S.C. 6119(e) & 37 C.F.R. 41.78

This nonprovisional application claims priority based upon the following prior U.S. provisional patent application entitled: Keyless home entry, application Ser. No.: 60/678,536, filed May 6, 2005, in the name of Eric M. Norton, which is hereby incorporated by reference for all purposes.

### FIELD OF THE INVENTION

The present invention relates locking devices for buildings, more specifically but not by way of limitation to a locking device for preventing unauthorized access to a building through a doorway as well as for controlling certain environment settings of the building, such as the lighting, with the locking device being operated by a wireless remote.

### BACKGROUND

The security of individuals and their possessions are a principal concern of any populace. In order to ensure that there is an overall feeling of protection and security within a governmental boundary, various agencies are created, manned, and maintained. Among the basic organized forces that can intervene for and on behalf of individuals and groups are police agents, and fire and rescue agents. With a strong set of organized and well equipped protective departments readily available, a community can function under an atmosphere of security.

Even with all of the organized forces, safety is the responsibility of the individual. A homeowner, for example, will implement safety measures designed to protect their possessions from theft or damage. These measures include the use of locks on windows and doors. Furthermore, homeowners will utilize electronic alarm or security systems in addition to conventional locks. Many of these safety measures utilized by individuals require keys to be activated and deactivated. Key and locks are utilized by individuals, not only in household applications, but also for automobiles, offices, mailboxes, garages and safety deposit boxes and numerous other devices. However, there are several disadvantages in using a key and lock setup. One issue is when a homeowner is returning home at night, it is often very difficult to find a key, especially when at the bottom of a pocketbook. Additionally, once found, it is often difficult to be able to see the keyhole to insert the key. The difficulties are compounded when the homeowner's hands are full of bags or packages. As can be appreciated, the longer a homeowner stands outside their locked door attempting to gain access to their home, the less safe they are.

Accordingly there is a need for a locking device that facilitates the access to a building in a manner as to minimize the amount of time required to gain access to the building.

### BRIEF DESCRIPTION OF THE DRAWING FIGURE

A more complete understanding of the present invention may be had by reference to the following Detailed Description and appended claims when taken in conjunction with the accompanying Drawing wherein:

FIG. 1 illustrates a perspective view of a wireless transmitter keychain and a wireless the receiver/controller/controller integrated with a conventional door lock mechanism.

### DETAILED DESCRIPTION

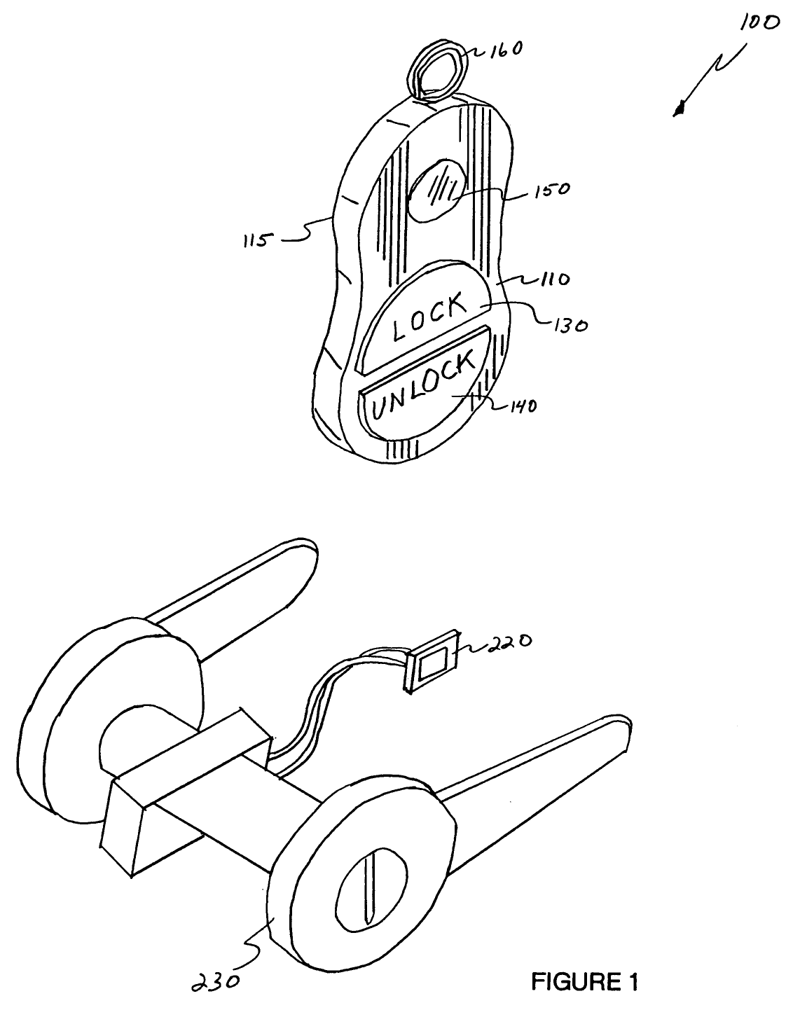

Referring now to the drawing wherein the various elements depicted therein are not necessarily drawn to scale, and in particular to FIG. 1, there is illustrated a preferred embodiment of a remote controlled locking system 100. As illustrated the remote controlled locking device 100 includes a wireless transmitter 110 and a receiver/controller 220.

The wireless transmitter 110 includes various actuators or buttons, such as buttons 130, 140. The wireless transmitter further includes a light 150. The wireless transmitter 110 has disposed therein conventional circuitry and power supply functioning to transmit signals to the receiver/controller 220. The wireless transmitter 110 has disposed therein a renewable power source such as but not limited to a lithium ion battery to provide power to the electronic circuitry.

It is contemplated that numerous different types of signals could be utilized by the wireless transmitter 110 to communicate with the receiver/controller 220. More specifically but not by way of limitation, the wireless transmitter 110 could utilize radio-frequency signals or infra-red signals to communicate with the receiver/controller 220. Those skilled in the art will recognize that each of the various buttons 130, 140 could be of different shapes and located in a plurality of positions on the wireless transmitter 110 to facilitate the user being able to determine which button 130, 140 or series of buttons to depress just by feeling the shape and position of the buttons.

It is contemplated within the scope of the present invention that the semicircular buttons 130 and 140 function as the unlock and lock buttons for a door configured with the receiver/controller 220. It is further contemplated within the scope of the present invention contemplated that the buttons 130, 140 of wireless transmitter 110 could also be constructed with illuminating material such that they glow in the dark. Those skilled in the art should recognize that a plurality of buttons could be present in order to perform a variety of other functions such as but not limited to controlling at least one light in the building being entered. Furthermore, the buttons 130, 140 could be of varying colors for ease of recognition.

The wireless transmitter 110 is comprised of a housing 115. The housing 115 is manufactured from a suitable durable material such as but not limited to thermoplastics. It is contemplated within the scope of the present invention that the housing 115 be constructed so as to be water resistant and shatterproof. As is further illustrated, the wireless transmitter 110 includes an attachment ring 160 such that the entire wireless transmitter 110 is incorporated in a typical sized key fob. The attachment ring 160 functions to facilitate the attachment of objects such as but not limited too keys to the wireless transmitter 110.

As can be appreciated, one advantage of remote controlled locking device 100 utilizing a wireless transmitter 110 is that it facilitates easy unlocking of a door when the user's hands are filled, such as when carrying other items. Although no specific size for the wireless transmitter is required, good results have been achieved with a wireless transmitter 110 that is manufactured to be approximately three to four inches in length, two to two and a half inches in width and one-half to three-quarters inches in thickness.

The light 150 is a conventional low voltage light such as but not limited to a LED light. The light 150 functions to facilitate easier viewing of the buttons 130, 140 in low light conditions. The light 150 further functions to provide a visual signal to the user that one of the buttons 130,140 has been engaged by flashing subsequent to the engagement of the buttons 130,140. It is further contemplated within the scope of the present invention that the light 150 could be manufactured to be a plurality of colors such as but not limited to red or green.

The receiver/controller 220 has disposed therein conventional electronic circuitry that is programmed to receive signals transmitted from the wireless transmitter 110 and functions to control the locking and unlocking of a door. In a preferred embodiment, receiver/controller 220 would be connected to or integrated with a door knob or conventional deadbolt locking mechanism, such that the control of locking and unlocking the door would be easily facilitated. The receiver/controller 220 is operably connected to a conventional power supply that is located within a building. It is contemplated within the scope of the present invention that an alternative embodiment utilizing a power source such as a battery for providing power to the receiver/controller 220 in order to facilitate ease of retrofitting an existing door with the remote control locking system 100. It is further contemplated that various power supplies could be implemented, such as but not limited to utilizing a solar powered charger.

It is contemplated within the scope of the present invention that various security features could be implemented in wireless transmitter 10. More specifically but not by way of limitation, the wireless transmitter could require the pressing of a certain combination of buttons 130, 140 to activate the operation the receiver/controller 220 to perform the function of unlocking or locking a door. It is further contemplated that other security measures could be implemented into the wireless transmitter 110 to prevent the unauthorized use thereof. More specifically but not by way of limitation, the wireless transmitter could utilize a biometrics reading system in place of and/or in conjunction with the buttons 130, 140. Additionally it is contemplated that the signals transmitted from wireless transmitter 110 be encrypted to prevent an unauthorized receiver/controller from utilizing or copying the signals.

The wireless transmitter 110 could be manufactured in various shapes and colors, including a single color or multiple colors and patterns, such that, for example, a user could pick a shape and or color pattern to match either their home or their car.

In an alternative embodiment, it is contemplated that the remote controlled locking system 100 could further include at least one led light integrally mounted into the door lock 230. The led light could provide a visual signal to the user as to the security status of the door. More specifically but not by way of limitation, the door lock 230 could have an outer light encircling the door lock 230 to provide notification of an unlocked status and an adjacent inner light providing a status to the user the door lock is locked. It is also contemplated within the scope of the present invention that the remote control locking system 100 could be mounted to a plurality of doors on the same building and be simultaneously controlled once within range by the wireless transmitter 110.

Referring to FIG. 1, a description of the operation of the remote controlled locking system 100 is as follows. In use, when a user depresses one of the buttons 130, 140 on the wireless transmitter 110, a signal is transmitted from the wireless transmitter 110, and if the user is within operating range of the receiver/controller 120, the receiver/controller 120 will receive the transmitted signal. In response to the received signal, the receiver/controller 120 will perform a programmed function. For example, if a user is approaching a door, and depresses button 130, the wireless transmitter 110 will send a signal corresponding to the depression of the lock button 130. In response to the receiving of the lock signal, the receiver/controller 120 will control the unlocking of the door.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A building door keyless entry device, said device comprising;
a key fob, said key fob including a plurality of buttons and a transmitter, said transmitter for transmitting a signal in response to the depression of at least a first of said plurality of buttons; and
a controller, said controller proximate said building door, said controller for receiving said signal transmitted from said transmitter, said controller for controlling the unlocking and locking of a door in response to receiving said signal transmitted from said transmitter.

2. The device as recited in claim 1, wherein each of said plurality of buttons is a different shape to facilitate the identification of each of said plurality of buttons by shape.

3. The device as recited in claim 1, wherein said key fob includes a power supply, said power supply being a lithium ion battery.

4. The device as recited in claim 2, wherein said transmitter being operably engaged upon the depression of a pattern of said plurality of buttons.

5. The device recited in claim 1, wherein said key fob includes a light, said light operable in response to a user depressing one of said plurality of buttons.

6. The device as recited in claim 1, wherein said controller is configured for controlling the locking of said building door in response to receiving a signal from said transmitter.

7. The device as recited in claim 1, wherein said controller is configured for controlling the unlocking of said building door in response to receiving a signal from said transmitter.

8. A door locking device for a home comprising:
a wireless transmitter for transmitting signals, said transmitter including a first button and a second button, said transmitter transmitting a first signal in response to the depression of the first button, and said transmitter transmitting a second signal in response to the depression of the second button; and
a controller positioned in a home, said controller proximate at least one door in said home, said controller for controlling the unlocking and locking of the door in the home in response to said controller receiving the first signal and the second signal transmitted from said wireless transmitter.

9. The door locking device as recited in claim 8, and further including a key fob, with said transmitter positioned in said key fob.

10. The door locking device as recited in claim 9, wherein said first signal is an unlocking signal, such that said controller unlocks the door in the home in response to receiving the first signal.

11. The door locking device as recited in claim 10, wherein said second signal is a locking signal, such that said controller locks the door in the home in response to the receiving the second signal.

12. The door locking device recited in claim 11, wherein said first signal and said second signal are encrypted when transmitted.

13. The door locking device as recited in claim 12, wherein said key fob is configured to permit select users to operate said transmitter.

14. The door locking device as recited in claim 13, wherein said first button is a first shape and said second button is a second shape to facilitate the identification of each of said buttons by shape.

15. A remote controlled door locking and unlocking system, comprising:
a wireless transmitter for transmitting signals, said transmitter including a first and a second button, said transmitter operable to transmit a signal in response to the depression of at least one of said first button and said second button; and
a controller positioned in a home, said controller proximate at least one door in said home, said controller for controlling the unlocking and locking of a door in the home in response to said controller receiving a signal transmitted from said transmitter.

16. The system as recited in claim 15, wherein said transmitter operable to transmit an unlock signal in response to the depression of the first button.

17. The system as recited in claim 16, wherein said transmitter operable to transmit a lock signal in response to the depression of the second button.

18. The system as recited in claim 17, wherein said wireless transmitter further includes a light, said light being operable in response to depression of one of said first button and said second button.

19. The system as recited in claim 18, wherein said first button is a first shape and said second button is a second shape, such that a user can identify the first button and the second button by the shape.

20. The system as recited in claim 29, wherein said wireless transmitter is operable in response to the depression of a preselected pattern of the first button and the second button.
